(19) United States
(12) Patent Application Publication
(10) Pub. No.: US 2010/0235274 A1
(43) Pub. Date: Sep. 16, 2010

(54) Anti-terror platform for securing a community against terrorisms

(76) Inventor: Yu-Chiuan Chen, Taipei (TW)

Correspondence Address: Yu-Chiuan Chen, 7084 Meadow Ridge, Corona, CA, 92880, US

(21) Appl. No.: 11/366,970

(22) Filed: Mar. 3, 2006

(51) Int. Cl. G06Q 99/00; G06F 17/30; G06F 21/00; G06Q 40/00

(52) U.S. Cl. 705/39; 707/802; 726/11; 707/E17.005; 707/E17.044

(57) ABSTRACT

An anti-terror platform for securing a community against terrorisms is disclosed. The platform includes following elements: (1) an anti-terror system, with an anti-terror server via a closed network connecting to a plurality of pre-contracted stations, wherein the closed network isn't invaded by a hacker; (2) an inputting frame, configured in the pre-contracted stations for inputting and transmitting terror data to the anti-terror server; (3) an anti-terror database, configured in the anti-terror server and maintained by an anti-terror expert system for receiving and correlating the terror data with historic terror data of the anti-terror database; (4) a resolving module, configured in the anti-terror server for estimating a probability of terrorism based on a result correlated by the anti-terror database and obtaining a terror warning according to the probability; and (5) a broadcasting module, configured in the anti-terror server for informing the pre-contracted stations of the terror warning.

### BACKGROUND OF THE INVENTION

1. Field of the Invention

The present invention relates generally to security and anti-terror features for a community, and more particularly to an anti-terror platform and method for securing a community against terrorisms.

2. Description of the Prior Art

British Prime Minister Tony Blair said the international community must confront extremist ideology to succeed in fighting the type of terrorism responsible for the recent attacks against London's transit system. Londoners have been tested by the Jul. 7, 2005 bombings that killed 52 people in three subway trains and a bus, and the failed July 21 attacks against similar targets, but their response had been “magnificent,” Blair said at his monthly news conference. “I do think the way that London has responded has been magnificent, not because people haven't been worried. Concerned? Of course they are, but because they have not allowed their worry and concern to overcome their determination to carry on with their lives,” he said. There is no justification for suicide bombers anywhere in the world, Blair said, insisting that the international community should not “give an inch” to terrorists. Once, Blair met with opposition party leaders to discuss new anti-terror legislation, with both sides expressing unity in their determination to fight terrorism.

For all practical purposes, the United States and other countries did not have to deal with the issue of generalized terror until Sep. 11, 2001. Events following the destruction of the World Trade Center's Twin Towers included explosions in Spain, Indonesia and Great Briton.

After the “911” incident, anti-terror issues for the whole world have become an invisible and unlimited war. Terrorists and the U.S. Government have publicly stated that this is just the beginning. It is the war on terror that draws peoples together in their daily lives and works. The U.S. has demonstrated strong resolve to take any required actions against terrorisms as part of national security strategies.

A revised blueprint for UN reform for world leaders to consider adopting at an upcoming summit includes a political definition of terrorism for the first time, which indicates broad support on a contentious global issue. If approved by the leaders in September 2005, the definition could break the impasse over a comprehensive treaty against terrorism which has been stalled for years over the question: who is a terrorist? That debate has focused especially on the Arab-Israeli conflict and the issue that one nation's terrorists are another's freedom fighters.

The blueprint issued would commit world leaders to adopting a comprehensive convention against terrorism by September 2006. Negotiations are expected to resume shortly in the UN General Assembly's legal committee, which would have to turn the political definition into legal language. A comprehensive treaty, first proposed by India, would incorporate key elements from more than a dozen anti-terrorism conventions already on the books. The aim is to raise worldwide standards for fighting terrorism.

Since the Sep. 11, 2001 attacks, some US jurisdictions have improved their rudimentary closed-circuit TV (CCTV) systems, branded by opponents as “spy” cameras. Chicago has around 1,200 cameras, there are more than 200 in Baltimore and there are 20 to 25 police cameras in Washington, as well as a network in Metro subway stations, trains and buses, according to Electronic Privacy Information Center (EPIC).

Suspected of trying to bomb a bus by the Jul. 7, 2005 was believed to have visited recently. In a city where it is impossible to escape the lens of half a million surveillance cameras, the suspects in the two London bombings never tried to hide their faces.

It is the structural veracity and unmindful of the community that allowed the terrorists to successfully place their terror-causing, disease-causing, destructive, or deadly matters.

There are no previous inventions that have dealt with the problem of terrorism and a solution via a community of human bodies. No prior art exists for such a community that uses huge potentials of virtual world created by computers and networks to unite real world for purposes of protection from terror, and the restoration of confidence in the public. There is no prior art regarding a closed computer network one of whose purposes is to warn the elements as to the possibility that potentially harmful, hazardous, injurious, terror-causing, disease-causing, destructive, or deadly matters may be hidden in the community. There is no prior art that warns the peoples as to the possible presence of objectionable materials within the community allowing an opportunity for the peoples to take precautions or notify appropriate authorities, such as Police, InterPol, FBI, CIA, prior to happening accidents. There is no prior art regarding a computer network one of whose purposes is to protect the elements and those in relative proximity to them from potential harm and injury that may be hidden in the community.

### SUMMARY OF THE INVENTION

The object of the present invention is to solve the above-mentioned problems and to provide an anti-terror platform for securing a community against terrorisms that uses huge potentials of virtual world created by computers and networks to unite real world to improve social security.

The present invention achieves the above-indicated objective by providing an anti-terror platform for securing a community against terrorisms. The platform includes following elements: (1) an anti-terror system, with an anti-terror server via a closed network connecting to a plurality of pre-contracted stations, wherein the closed network isn't invaded by a hacker; (2) an inputting frame, configured in the pre-contracted stations for inputting and transmitting terror data to the anti-terror server; (3) an anti-terror database, configured in the anti-terror server and maintained by an anti-terror expert system for receiving and correlating the terror data with historic terror data of the anti-terror database; (4) a resolving module, configured in the anti-terror server for estimating a probability of terrorism based on a result correlated by the anti-terror database and obtaining a terror warning according to the probability; and (5) a broadcasting module, configured in the anti-terror server for informing the pre-contracted stations of the terror warning.

According to another aspect of the present invention, an anti-terror method for securing a community against terrorisms for an anti-terror system with an anti-terror server via a closed network connecting to a plurality of pre-contracted stations first configures an inputting frame for inputting and transmitting terror data. Next, the terror data are received and correlated with historic terror data of the anti-terror database, wherein the anti-terror database is configured and maintained by an anti-terror expert system. Next, based on a result correlated by the anti-terror database, a probability of terrorism is estimated, and a terror warning according to the probability is obtained. Finally, the terror warning is informed to the pre-contracted stations.

### BRIEF DESCRIPTION OF THE DRAWINGS

The present invention will be described in detail with reference to the illustrated embodiment and the accompanying drawings, in which:

FIG. 1 is a block diagram of an anti-terror platform for securing a community against terrorisms in the embodiment 1 of the present invention.

FIG. 2 is a flow chart showing the steps for an anti-terror method for securing a community against terrorisms in the embodiment 1 of the present invention.

### DETAILED DESCRIPTION OF THE INVENTION

Efforts to upgrade the schools must come from the community.

Efforts to upgrade anti-terror capabilities must come from general populations

The present invention discloses how to use huge potentials of virtual world created by computers and networks to unite real world to improve social security, struggle against terrorisms and upgrade the quality of lives.

A community of human bodies could be an Intellectual Community if the huge potentials of virtual world are well utilized. Some of human communities are very advanced, especially around a university, a research institute, a corporation's headquarters or a government organization, and those advanced communities could be Information Clusters.

An Intellectual Community can be established if it has an intelligent center located in a university, research institute, corporation's headquarters or government organization of said Community. Know-how of information technologies and business managements can be introduced into the Intellectual Community through the intelligent center. Then, families, schools, dormitories, hospitals, stores, financial institutions and police stations of the Intellectual Community can be organized like an enterprise entity. Human resources, objects and times of the Intellectual Community can be utilized efficiently. Accordingly, the Intellectual Community can be a demonstrated site for social security or creating, developing, testing or analyzing novel products or services, in-situ.

The Intellectual Community in the present invention is also referred to as an anti-terror platform or a knowledge-based platform in preferred embodiments. The anti-terror platform or the knowledge-based platform includes units of the Community, such as families, schools, dormitories, hospitals, stores, financial institutions and police stations, automatic systems and interactive systems between cooperated companies and the Community thereof. The automatic systems include soft ware, firmware, hardware, electronic communications, electronic devices, electric appliances and human resources that are pre-contracted with the anti-terror platform or the knowledge-based platform. The interactive systems of the Intellectual Community are used for communicating with organizations out of the area of the Community.

Within this description, the term “platform” and “system” are understood to comprise all kinds of computer or phone networking, wire or wireless. The term “server” and “station” are understood to include all kinds of computer, information appliances, mobile telephones, GPS receivers, satellite telephones, electronic cameras, television receivers, broadcast control systems, medical monitoring devices, security devices, environmental control systems and electronic devices.

### Embodiment 1

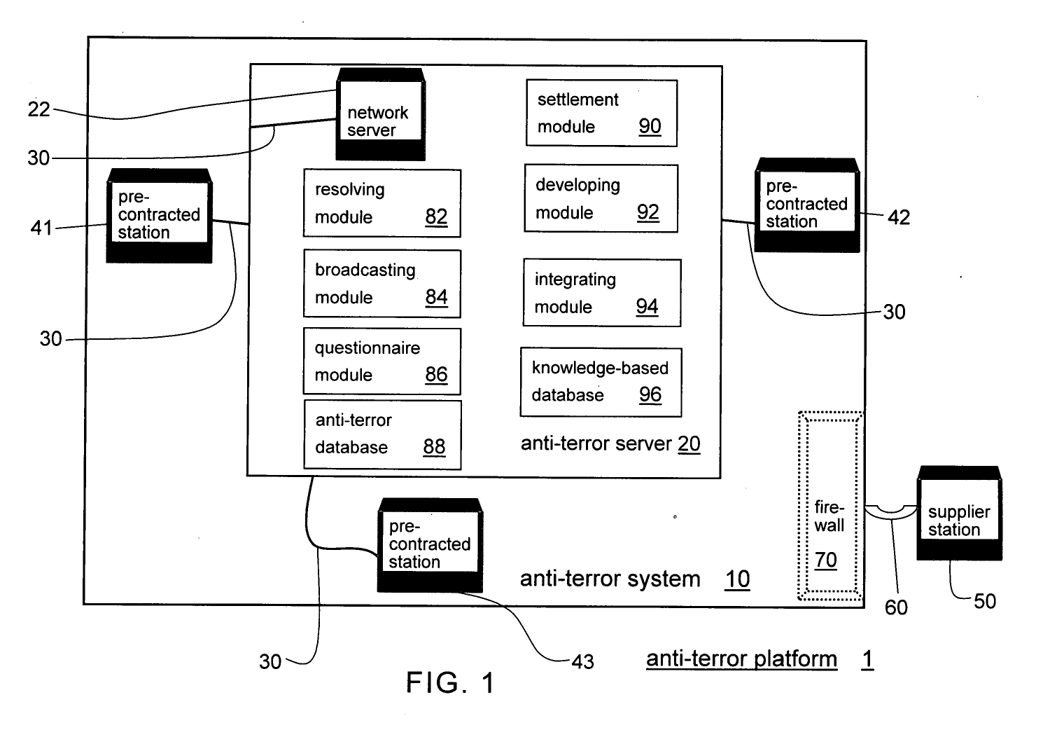

FIG. 1 is a block diagram of an anti-terror platform for securing a community against terrorisms in the embodiment 1. As shown in FIG. 1, the anti-terror platform 1 includes an anti-terror system 10, a special line 60 and a supplier station 50. The special line 60 is a dedicated connection between the anti-terror system 10 and the supplier station 50 such that a hacker or virus can be separated. As above declared, the anti-terror platform 1 is also referred to as the Intellectual Community. The anti-terror system 10 is automatic and includes the human resources pre-contracted with the anti-terror platform 1.

The anti-terror system 10 further includes an anti-terror server 20, a plurality of pre-contracted stations 41, 42 and 43, a closed network 30 and a firewall 70. The closed network 30 is dedicated connections between the anti-terror server 20 and pre-contracted stations 41, 42 and 43 such that a hacker or virus can be separated. The firewall 70 is configured in the anti-terror system 10 and used for preventing a hacker or virus when other computers or networks are linked to the anti-terror system 10. The anti-terror server 20 is actually located in an academy, university, research institute, corporation's headquarters, government organization, military institute or police station of the Intellectual Community. Each of the pre-contracted stations is separately located in all units of the Community including families, schools, dormitories, hospitals, stores, financial institutions and police stations that are pre-contracted with the anti-terror platform 1.

The anti-terror server 20 includes a network server 22, a resolving module 82, a broadcasting module 84, a questionnaire module 86, an anti-terror database 88, a settlement module 90, a developing module 92, an integrating module 94 and a knowledge-based database 96. The network server 22 is optional, and is located in the anti-terror server 20 and used for connecting the pre-contracted stations 41, 42 and 43.

An inputting frame is configured in the pre-contracted stations 41, 42 and 43 by the anti-terror system 10 or the anti-terror server 20. The inputting frame is used for inputting terror data on a screen of each computer or server of the anti-terror platform 1 and transmitting the terror data to the anti-terror server 20. The anti-terror database 88 is configured in the anti-terror server 20 and maintained by an anti-terror expert system for receiving and correlating the terror data with historic terror data of the anti-terror database 88. Wherein the anti-terror expert system is implemented by a government or organization to integrate all of the experts related to social security or country security. The anti-terror expert system can create, configured, update and maintain the anti-terror database 88.

The resolving module 82 is configured in the anti-terror server 20 for estimating a probability of terrorism based on a result correlated by the anti-terror database 88 and obtaining a terror warning according to the probability. The broadcasting module 84 is configured in the anti-terror server 20 for informing the pre-contracted stations 41, 42 and 43 of the terror warning. Alternatively, before the broadcasting module 84 informing the pre-contracted stations 41, 42 and 43, the resolving module 82 can notify the anti-terror expert system of the terror warning. Then, the anti-terror expert system re-estimates if the terror warning need be informed or not. If necessary, the anti-terror expert system informs the decided terror warning to the pre-contracted stations 41, 42 and 43.

The anti-terror platform 1 of the present invention is suitable for a business model of Community to Business for securing goods supplying in response to the terror warning. In order to achieve the object for securing goods supplying, the anti-terror server 20 further comprises the pre-contracted supplier station 50. An inputting table is configured in the pre-contracted stations for inputting a purchasing quantity and a serial number of the goods on a screen of each computer or server of the anti-terror platform 1 and transmitting the purchasing data of the goods to the anti-terror server 20. The anti-terror server 20 creating a purchase sheet when the purchasing quantity reaches a certain number or a pre-contracted deadline is due. The pre-contracted supplier station 50 is used for obtaining the purchase sheet and providing the goods according to the purchase sheet through an electronic transaction between the pre-contracted supplier station 50 and the anti-terror server 20, wherein the pre-contracted supplier station 50 gives a preference, a special discount or a coupon for the purchase sheet. The electronic transaction is through a closed line, a dedicated connection or a securing computer network with the firewall 70.

The goods transacted in the anti-terror platform 1 comprise real goods, virtual goods, consultation, stocks exchange, financial service, information service or business service. The settlement module 90 is configured in the anti-terror server 20 for transferring the price of the goods to an account of the pre-contracted supplier station 50 at a financial institution or with a credit card used for the electronic transaction. The questionnaire sending and receiving module 86 is configured in the anti-terror server 20 for sending a questionnaire constructed beforehand to the pre-contracted stations 41, 42 and 43, and receiving a result of the questionnaire. The questionnaire is designed by the anti-terror expert system or other pre-contracted organizations. Information of the result of the questionnaire would be much more useful if it could upgrade anti-terror capabilities of the anti-terror platform 1, or if it could warn the anti-terror platform 1 that a module of the anti-terror system 10 need be added or modified. With more accurate information of results of questionnaires, the anti-terror platform 1 could improve the anti-terror system 10 that are better matched to requirements of the community's members, resulting in less inaccuracy of the anti-terror system 10.

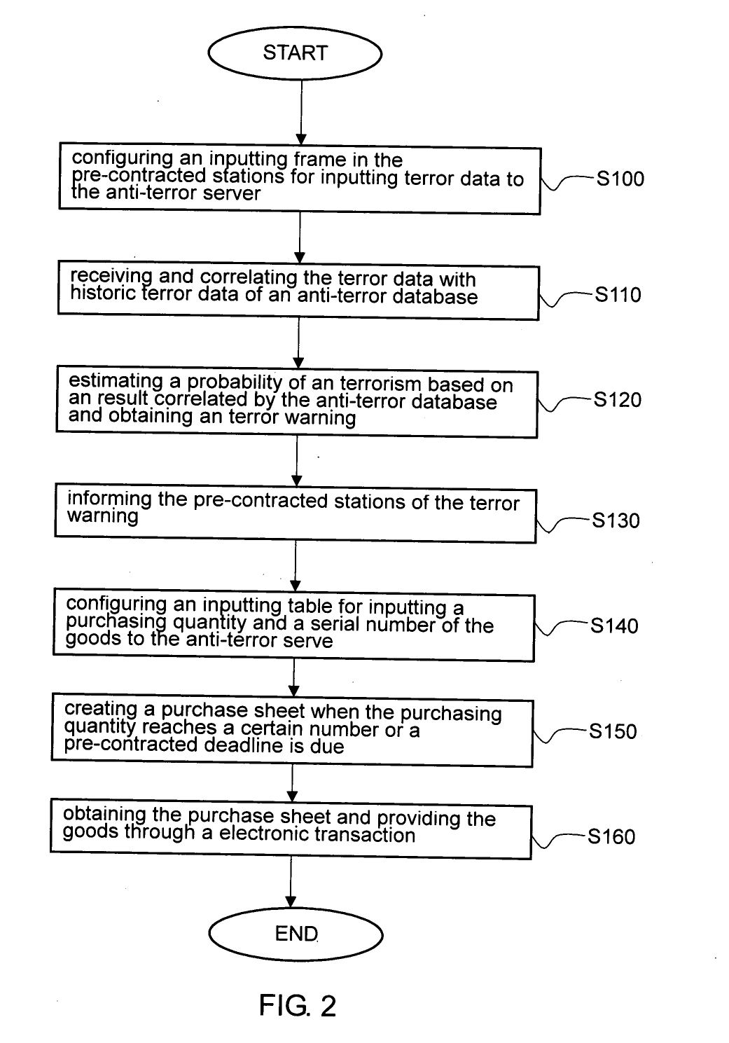

FIG. 2 is a flow chart showing the steps for an anti-terror method for securing a community against terrorisms in the embodiment 1. The method for securing a community against terrorisms for the anti-terror system 10 with the anti-terror server 20 via the closed network 30 connecting to the plurality of pre-contracted stations 41, 42 and 43, wherein the closed network 30 isn't invaded by a hacker or virus. The process first configures an inputting frame for inputting and transmitting terror data to the anti-terror server 20, as shown in step S100.

In step S110, the terror data are received and correlated with historic terror data of the anti-terror database 88, wherein the anti-terror database 88 is configured in the anti-terror server 20 and maintained by an anti-terror expert system.

In step S120, based on a result correlated by the anti-terror database, a probability of terrorism is estimated, and a terror warning according to the probability is obtained.

In step S130, the terror warning is informed to the pre-contracted stations 41, 42 and 43.

The anti-terror method of the present invention is suitable for a business model of Community to Business for securing goods supplying in response to the terror warning. In order to achieve the object for securing goods supplying, the anti-terror server 20 further comprises the following steps.

In step S140, an inputting table is configured for inputting and transmitting a purchasing quantity and a serial number of the goods to the anti-terror server 20.

In step S150, a purchase sheet is created when the purchasing quantity reaches a certain number or a pre-contracted deadline is due.

In step S150, through an electronic transaction between the pre-contracted supplier station 50 and the anti-terror server 20, the purchase sheet is obtained and the goods are provided according to the purchase sheet, wherein the pre-contracted supplier station 50 gives a preference, a special discount or a coupon for the purchase sheet.

### Embodiment 2

The anti-terror platform 1 of FIG. 1 of the present invention is also referred to as a knowledge-based platform. The knowledge-based platform 1 is suitable for a business model of Community to Business. The knowledge-based platform 1 is, except as described below, similar to the anti-terror platform 1 and like reference numerals or terms are used to indicate like parts with the same configuration and function.

The knowledge-based platform 1 includes an intelligent system 10, a special line 60 and a supplier station 50. The special line 60 is a dedicated connection between the intelligent system 10 and the supplier station 50 such that a hacker or virus can be separated.

The intelligent system 10 includes an intelligent server 20, a plurality of pre-contracted stations 41, 42 and 43, a closed network 30 and a firewall 70. The closed network 30 is dedicated connections between the intelligent server 20 and pre-contracted stations 41, 42 and 43 such that a hacker or virus can be separated. The firewall 70 is configured in the intelligent system 10 and used for preventing a hacker or virus when other computers or networks are linked to the intelligent system 10.

The intelligent server 20 includes a network server 22, a resolving module 82, a broadcasting module 84, a questionnaire module 86, an intelligent database 88, a settlement module 90, a developing module 92, an integrating module 94 and a knowledge-based database 96. The network server 22 is optional, and is located in the intelligent server 20 and used for connecting the pre-contracted stations 41, 42 and 43.

The knowledge-based database 96 is configured in the intelligent server 20 and maintained by a knowledge-based expert system for receiving, collecting and analyzing records of each of the electronic transaction. Wherein the knowledge-based expert system is implemented by a government or organization to integrate all of the experts related to all fields of sciences or knowledge-based economy. The knowledge-based expert system can create, configured, update and maintain the knowledge-based database 96. The integrating module 94 is configured in the intelligent server 20 for integrating a solution based on the records analyzed by the knowledge-based database 96 and obtaining a strategy. The developing module 92 is configured in the intelligent server 20 for developing a novel product or service based on the strategy.

The questionnaire sending and receiving module 86 in the Embodiment 2 is configured in the intelligent server 20 for sending a questionnaire constructed beforehand to the pre-contracted stations 41, 42 and 43, and receiving a result of the questionnaire. The questionnaire is designed by the knowledge-based expert system or other pre-contracted organizations. Information of the result of the questionnaire would be much more useful if it could upgrade knowledge capabilities of the knowledge-based platform 1, or if it could advise the knowledge-based platform 1 that a module of the intelligent system 10 need be added or modified. With more accurate information of results of questionnaires, the knowledge-based platform 1 could improve the intelligent system 10 that are better matched to requirements of the community's members, resulting in much accuracy of the intelligent system 10. The developing module 92 is configured in the intelligent server 20 for developing a novel product or service based on the strategy.

Information of the result of the questionnaire is also very valuable due to it could guide the integrating module 94 to form a much meaningful strategy to help the supplier station 50 to improve existing products or services and develop novel products or services, resulting in popular products or services matched to desires of most consumers. The supplier station 50 can also query and analyze the result of the questionnaire in many ways, including the calculation of actual instantaneous and historical consumer demand for products and product categories. The supplier station 50 uses the information of the result of the questionnaire to assist with market analysis of various kinds of demand and to target consumers.

### Other Embodiments

The foregoing description is of a preferred embodiment of the invention. Other embodiments are anticipated. For example, it is expected that future embodiments of the invention will use a variety of computer, communication or consumer (3C) devices, such as, but not limited to, Digital Still Camera (DSC), Digital Video (DV), Personal Digital Assistant (PDA), mobile electronic device, 3G mobile phone, cellular phone, smart phone, Voice Over Internet Protocol (VoIP) or Skype.

It is also anticipated that, in the future, the platform will further comprise actual anti-terror actions.

It is also anticipated that additional kinds of data will be collected by the platform, and additional methods of analysis of such data will be developed.

It is to be understood that the present invention is not limited to the embodiments described above, but encompasses any and all embodiments within the scope of the following claims.

1. An anti-terror computer network platform for securing a community against terrorisms, comprising:
an anti-terror system, with an anti-terror server via a closed network connecting to a plurality of pre-contracted stations, wherein the closed network isn't invaded by a non pre-contracted electric device;
an inputting frame, configured in the pre-contracted stations for inputting and transmitting currently potentially harmful, hazardous, injurious, terror-causing, disease-causing, destructive, or deadly matters hidden in the community to the anti-terror server;
an anti-terror database, configured in the anti-terror server and maintained by an anti-terror expert system for receiving and correlating the currently potentially harmful, hazardous, injurious, terror-causing, disease-causing, destructive, or deadly matters hidden in the community with historic terror data of the anti-terror database;
a resolving module, configured in the anti-terror server for estimating a probability of terrorism based on a result correlated by the anti-terror database and obtaining a terror warning according to the probability;
a broadcasting module, configured in the anti-terror server for informing the pre-contracted stations of the terror warning;
a pre-contracted supplier station, connecting to the anti-terror system via a dedicated line, for securing a supply of goods in response to the terror warning; and
an inputting table, configured in the pre-contracted stations for inputting and transmitting a purchasing quantity and a serial number of the goods to the anti-terror server in response to the terror warning, the anti-terror server creating a purchase sheet when the purchasing quantity reaches a certain number or a pre-contracted deadline is due;
wherein the pre-contracted supplier station is configured to obtain the purchase sheet and provide the goods according to the purchase sheet through an electronic transaction between the pre-contracted supplier station and the anti-terror server.

2. The anti-terror computer network platform as recited in claim 1,
wherein the pre-contracted supplier station gives a preference, a special discount or a coupon for the purchase sheet.

3. The anti-terror computer network platform as recited in claim 2, wherein the electronic transaction is through a secure computer network with a firewall.

4. The anti-terror computer network platform as recited in claim 2, wherein the goods comprise consultation, stocks exchange, financial service, information service or business service.

5. The anti-terror computer network platform as recited in claim 2, further comprising a settlement module configured in the anti-terror server for transferring the price of the goods to an account of the pre-contracted supplier station at a financial institution or with a credit card used for the electronic transaction.

6. The anti-terror computer network platform as recited in claim 2, further comprising a questionnaire sending and receiving module configured in the anti-terror server for sending a questionnaire constructed beforehand to the pre-contracted stations and receiving a result of the questionnaire.

7. The anti-terror computer network platform as recited in claim 1, wherein the anti-terror server is located in an academy, university, research institute, corporation's headquarters, government organization, military institute or police station.

8. The anti-terror computer network platform as recited in claim 1, wherein the anti-terror expert system is implemented by a government or organization to integrate all of the information related to social security or country security.

9. An anti-terror method for securing a community against terrorisms implemented using an anti-terror system with an anti-terror server via a closed network connecting to a plurality of pre-contracted stations, wherein the closed network isn't invaded by a non pre-contracted electric device, and wherein the anti-terror server includes a resolving module, and a broadcasting module, the method comprising the steps of:
configuring an inputting frame in the pre-contracted stations for inputting and transmitting currently potentially harmful, hazardous, injurious, terror-causing, disease-causing, destructive, or deadly matters hidden in the community;
receiving and correlating the currently potentially harmful, hazardous, injurious, terror-causing, disease-causing, destructive, or deadly matters hidden in the community with historic terror data of an anti-terror database, wherein the anti-terror database is configured in the anti-terror server and maintained by an anti-terror expert system;
the resolving module estimating a probability of terrorism based on a result correlated by the anti-terror database and obtaining a terror warning according to the probability;
the broadcasting module informing the pre-contracted stations of the terror warning;
securing a supply of goods in response to the terror warning from a pre-contracted supplier station connected to the anti-terror system via a dedicated line;
configuring an inputting table in the pre-contracted stations for inputting and transmitting a purchasing quantity and a serial number of the goods to the anti-terror server in response to the terror warning;
creating a purchase sheet in the anti-terror server when the purchasing quantity reaches a certain number or a pre-contracted deadline is due; and
obtaining the purchase sheet and providing the goods according to the purchase sheet through an electronic transaction between the pre-contracted supplier station and the anti-terror server.

10. The anti-terror method as recited in claim 9,
wherein the pre-contracted supplier station gives a preference, a special discount or a coupon for the purchase sheet.

11. The anti-terror method as recited in claim 10, wherein the goods comprise consultation, stocks exchange, financial service, information service or business service.

12. The anti-terror method as recited in claim 10, wherein the anti-terror server comprises a settlement module, further comprising a step of the settlement module transferring the price of the goods to an account of the pre-contracted supplier station at a financial institution or with a credit card used for the electronic transaction.

13. The anti-terror method as recited in claim 10, wherein the anti-terror server comprises a questionnaire module, further comprising a step of the questionnaire module sending a questionnaire constructed beforehand to the pre-contracted stations and receiving a result of the questionnaire.

14. The anti-terror method as recited in claim 10, wherein the anti-terror expert system is implemented by a government or organization to integrate all of the information related to social security or country security.

15-20. (canceled)
